(19) United States
(12) Patent Application Publication
(10) Pub. No.: US 2015/0262031 A1
(43) Pub. Date: Sep. 17, 2015

(54) Method And Apparatus For Identifying Picture

(71) Applicant: TENCENT TECHNOLOGY (SHENZHEN) COMPANY LIMITED, Shenzhen City (CN)

(72) Inventors: Quan WANG, Shenzhen (CN); Guoqiang WANG, Shenzhen (CN)

(21) Appl. No.: 14/723,826

(22) Filed: May 28, 2015

Related U.S. Application Data
(63) Continuation of application No. PCT/CN2013/087808, filed on Nov. 26, 2013.

(30) Foreign Application Priority Data
Dec. 6, 2012 (CN) 201210519692.1

(51) Int. Cl. G06K 9/62; G06F 3/0482

(52) U.S. Cl. CPC G06K 9/6217; G06F 3/0482

(57) ABSTRACT

A picture of a web page is a two-dimensional code picture and is determined when the picture is triggered. A user is prompted to determine whether to identify the two-dimensional code picture when the picture of the web page is the two-dimensional code picture. The two-dimensional code picture is parsed after receiving an instruction of identifying the two-dimensional code picture from the user. Two-dimensional code information is obtained, and processing is performed according to the two-dimensional code information.

### CROSS-REFERENCE TO RELATED APPLICATIONS

This application is a continuation of International Application No. PCT/CN2013/087808, filed Nov. 26, 2013. This application claims the benefit and priority of Chinese Application No. 201210519692.1, filed Dec. 6, 2012. The entire disclosures of each of the above applications are incorporated herein by reference.

### FIELD

The present disclosure relates to browser technologies, and to a method and apparatus for identifying pictures.

### BACKGROUND

This section provides background information related to the present disclosure which is not necessarily prior art.

A two-dimensional code records data symbol information by using particular geometry according to certain rules in a two-dimensional plane. A two-dimensional code picture may be automatically identified by using an image input device or optical scanning equipment, so that automatic processing of information is achieved.

Along with the development of communication technologies, two-dimensional code identification is widely used on networks. For example, the two-dimensional code identification may be used for login authentication, obtaining network information, e-commerce interactions, and so on. In the conventional two-dimensional code identification technologies, a camera connected to a terminal is used for scanning a two-dimensional code to obtain a two-dimensional code picture, or a two-dimensional code picture stored locally is directly obtained. The obtained two-dimensional code picture is decoded by using two-dimensional code identification software or by a client with two-dimensional code identification functions, which is installed on the terminal, so as to obtain two-dimensional code information.

In the above methods, if the two-dimensional code picture is obtained by using the camera of the terminal, the camera requires high resolution. Further, when the terminal needs to obtain a two-dimensional code picture from a web page, the terminal stores the two-dimensional code picture locally, exits the web page, and calls the two-dimensional code identification software on the terminal to decode the two-dimensional code picture. Hence, the conventional two-dimensional code identification process is very cumbersome.

### SUMMARY

This section provides a general summary of the disclosure, and is not a comprehensive disclosure of its full scope or all of its features.

Various embodiments of the present disclosure provide a method and apparatus for identifying a picture, so as to facilitate the user to identify a two-dimensional code picture.

A method for identifying a picture includes:

determining, by a computing device, whether a picture is a two-dimensional code picture, after the picture is triggered on a web page displayed by the computing device;

parsing, by the computing device, the two-dimensional code picture when the picture is the two-dimensional code picture;

obtaining, by the computing device, two-dimensional code information; and

performing, by the computing device, processing according to the two-dimensional code information.

An apparatus for identifying a picture includes:

a monitoring module, to determine whether a picture is a two-dimensional code picture after the picture is triggered on a web page displayed on the computing device;

a parsing module, to parse the two-dimensional code picture when the picture is the two-dimensional code picture; and obtain two-dimensional code information; and

a processing module, to perform processing according to the two-dimensional code information.

A method for obtaining two-dimensional code information, comprising:

displaying a webpage on a displaying screen of a computing device, the webpage presenting at least one picture;

identifying, by said computing device, two-dimensional code picture from the presented at least one picture to be parsed, while displaying the webpage, the two-dimensional code picture incorporating two-dimensional code;

parsing the two-dimensional code picture, by said computing device; and

obtaining, by one or more processor, two-dimensional code information.

According to various embodiments, the picture triggering event of the web page is monitored. When the two-dimensional code picture is triggered, the picture identification function is provided, so that the two-dimensional code picture on the web page browsed by the user may be identified directly, and it is unnecessary to identify the two-dimensional code picture by using a camera or by using a local picture identification software after storing the picture locally, thereby facilitating the user to use the picture identification function.

Further areas of applicability will become apparent from the description provided herein. The description and specific examples in this summary are intended for purposes of illustration and are not intended to limit the scope of the present disclosure.

### DRAWINGS

The drawings described herein are for illustrative purposes of selected embodiments and not all possible implementations, and are not intended to limit the scope of the present disclosure.

FIG. 1 is a flowchart illustrating a method for identifying a picture according to various embodiments.

FIG. 2 is a flowchart illustrating a procedure of obtaining two-dimensional information in a method for identifying a picture according to various embodiments.

FIG. 3 is a diagram illustrating a structure of an apparatus for identifying a picture according to various embodiments.

Corresponding reference numerals indicate corresponding parts throughout the several views of the drawings.

### DETAILED DESCRIPTION

Example embodiments will now be described more fully with reference to the accompanying drawings.

Various embodiments provide the following technical methods.

The following description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. For purposes of clarity, the same reference numbers will be used in the drawings to identify similar elements.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. The use of examples anywhere in this specification, including examples of any terms discussed herein, is illustrative and in no way limits the scope and meaning of the disclosure or of any exemplified term. Likewise, the disclosure is not limited to various embodiments given in this specification.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

As used herein, the terms “comprising,” “including,” “having,” “containing,” “involving,” and the like are to be understood to be open-ended, i.e., to mean including but not limited to.

As used herein, the phrase “at least one of A, B, and C” should be construed to mean a logical (A or B or C), using a non-exclusive logical OR. One or more processes within a method may be executed in different order (or concurrently) without altering the principles of the present disclosure.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term “code”, as used herein, may include software, firmware, and/or microcode, and may refer to programs, routines, functions, classes, and/or objects. The term “shared”, as used herein, means that some or all code from multiple modules may be executed using a single (shared) processor. In addition, some or all code from multiple modules may be stored by a single (shared) memory. The term “group”, as used herein, means that some or all code from a single module may be executed using a group of processors. In addition, some or all code from a single module may be stored using a group of memories.

The systems and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

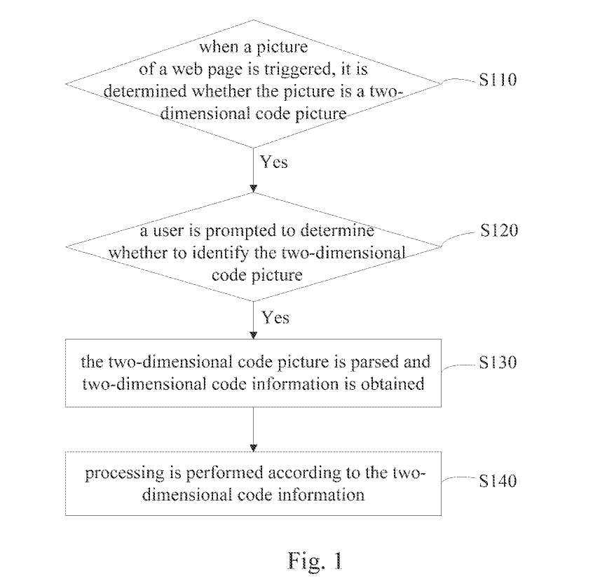

The description will be made as to the various embodiments in conjunction with the accompanying drawings in FIGS. 1-3. The various embodiments described herein are merely intended to explain the present disclosure, but not intended to limit the present disclosure. In accordance with the purposes of this disclosure, as embodied and broadly described herein, this disclosure, in one aspect, relates to method and apparatus for identifying a picture.

Examples of mobile terminals that can be used in accordance with various embodiments include, but are not limited to, a tablet PC (including, but not limited to, Apple iPad and other touch-screen devices running Apple iOS, Microsoft Surface and other touch-screen devices running the Windows operating system, and tablet devices running the Android operating system), a mobile phone, a smartphone (including, but not limited to, an Apple iPhone, a Windows Phone and other smartphones running Windows Mobile or Pocket PC operating systems, and smartphones running the Android operating system, the Blackberry operating system, or the Symbian operating system), an e-reader (including, but not limited to, Amazon Kindle and Barnes & Noble Nook), a laptop computer (including, but not limited to, computers running Apple Mac operating system, Windows operating system, Android operating system and/or Google Chrome operating system), or an on-vehicle device running any of the above-mentioned operating systems or any other operating systems, all of which are well known to one skilled in the art.

FIG. 1 is a flowchart illustrating a method for identifying a picture according to various embodiments. As shown in FIG. 1, the method includes the following processes.

S110: When a picture of a web page is triggered, it is determined whether the picture is a two-dimensional code picture. If the picture is the two-dimensional code picture, processing at S120 is performed; if the picture is not the two-dimensional code picture, the procedure is terminated.

S120: A user is prompted to determine whether to identify the two-dimensional code picture. If the user determines to identify the two-dimensional code picture, an instruction of identifying the two-dimensional code picture is sent from the user, and processing at S130 is performed; if the user determines not to identify the two-dimensional code picture, the procedure is terminated.

S130: The two-dimensional code picture is parsed and two-dimensional code information is obtained. According to various embodiments, the two-dimensional code picture may be parsed directly after it is determined that the picture is the two-dimensional code picture.

S140: Processing is performed according to the two-dimensional code information.

When the user browses a web page via a browser, the user may click a picture on the web page by using the right key of a mouse or may press the picture on the web page with their finger, so as to trigger the picture on the web page. The browser may be a web page browser on a PC or a browser on a mobile terminal, e.g. an UC browser or a QQ browser. According to various embodiments, when the picture on the web page is triggered, a shortcut menu is displayed, so that the user may save, copy, enlarge, or reduce the picture. The picture according to the various embodiments refers to a picture containing coding information, e.g. a two-dimensional code picture, or other types of pictures having the similar function of the two-dimensional code picture.

According to various embodiments, when the picture on the web page is triggered, a shortcut menu is displayed, and a picture identification function is added to the shortcut menu, that is, the shortcut menu includes the picture identification function. After the user chooses the picture identification function, i.e. an instruction of identifying the two-dimensional code picture is received from the user, the triggered picture is parsed, and code information, i.e. two-dimensional code information is obtained.

The two-dimensional code information may be text, an image or a URL address. The user may select to perform processing according to the two-dimensional code information. If the two-dimensional code information text, the text may be displayed or copied. If the two-dimensional code information is an image, the image may be displayed, enlarged, reduced, or rotated. If the two-dimensional code information is a URL address, the URL address may be copied, a link corresponding to the URL address may be opened. In addition, the processing corresponding to the type of two-dimensional code information may be performed automatically. For example, if the two-dimensional code information is the URL address, the link corresponding to the URL address may be opened directly.

According to various embodiments, a picture triggering event of the web page is monitored. When the two-dimensional code picture is triggered, the picture identification function is provided, so that the two-dimensional code picture on the web page browsed by the user may be identified directly. It is unnecessary to identify the two-dimensional code picture by using a camera or by using a local picture identification software after storing the picture locally, thereby facilitating the user to use the picture identification function.

In the processing at S130, picture resources triggered on the web page are extracted and then parsed according to parsing rules pre-stored in a parsing library, so as to obtain the two-dimensional code information.

According to various embodiments, after the user inputs a URL address or after the user clicks a URL address, the browser may obtain page resources of a web page corresponding to the URL address from a network server, and then display the web page.

The parsing procedure at S130 may be implemented by the browser or by a cloud server located between the browser and the network server. In the parsing procedure, the picture resources are parsed according to the parsing rules in a parsing library. There are various parsing rules in a parsing library, such as parsing rules for pictures containing text coding information and parsing rules for pictures containing URL address coding information. The parsing rules in the parsing library may be obtained from the network according to the requirements.

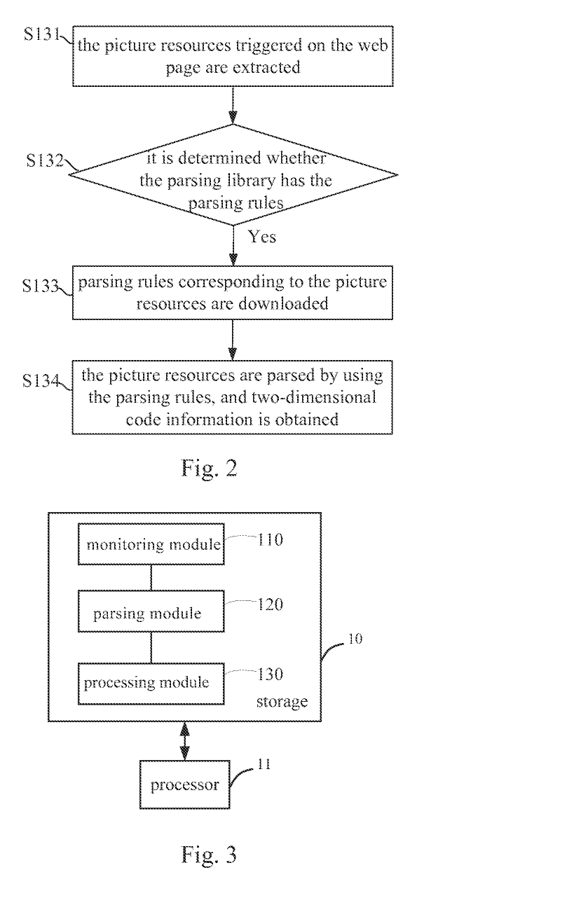

FIG. 2 is a flowchart illustrating a procedure of obtaining two-dimensional information in a method for identifying a picture according to various embodiments. As shown in FIG. 2, the processing at S130 is as follows.

S131: The picture resources triggered on the web page are extracted.

S132: It is determined whether the parsing library has the parsing rules. If the parsing library has the parsing rules, processing at S124 is performed; if the parsing library does not have the parsing rules, processing at S123 is performed.

S133: Parsing rules corresponding to the picture resources are downloaded, and processing at S124 is performed.

S134: The picture resources are parsed by using the parsing rules, and two-dimensional code information is obtained.

According to various embodiments, the parsing rules stored in the parsing library may be updated, thereby enriching types of the parsing rules in the parsing library, and enhancing the ability to identify the picture on the web page.

FIG. 3 is a diagram illustrating a structure of an apparatus for identifying a picture according to various embodiments. As shown in FIG. 3, the apparatus includes storage 10 and a processor 11. According to various embodiments, the storage 10 may be a non-transitory computer readable storage medium. The storage 10 stores computer readable instructions for implementing a monitoring module 110, a parsing module 120, and a processing module 130. The processor 11 may execute the computer readable instructions stored in the storage 10.

The monitoring module 110 determines whether a picture of a web page is a two-dimensional code picture when the picture is triggered and prompts a user to determine whether to identify the two-dimensional code picture when the picture of the web page is the two-dimensional code picture.

The parsing module 120 parses the two-dimensional code picture after receiving an instruction of identifying the two-dimensional code picture from the user and obtains two-dimensional code information. The processing module 130 performs processing according to the two-dimensional code information. When the user browsers a web page via a browser, the user may click a picture on the web page by using a right key of a mouse or may press the picture on the web page with their finger, so as to trigger the picture on the web page. The browser may be a web page browser on a PC or a browser on a mobile terminal, e.g. an UC browser or a QQ browser.

According to various embodiments, when the picture on the web page is triggered, a shortcut menu is displayed, so that the user may save, copy, enlarge, or reduce the picture. The picture according to various embodiments refers to a picture containing coding information, e.g. a two-dimensional code picture, or other types of pictures having the similar function of the two-dimensional code picture.

According to various embodiments, when the picture monitoring module 110 determines that the picture on the web page is triggered, a shortcut menu is displayed, and a picture identification function is added to the shortcut menu, that is, the shortcut menu includes the picture identification function. After the user chooses the picture identification function, i.e. after the parsing module 120 receives an instruction of identifying the two-dimensional code picture, the triggered picture is parsed, and code information, i.e. two-dimensional code information is obtained.

The two-dimensional code information may be text, an image or a URL address. The parsing module 130 may be triggered by the user to perform processing according to the two-dimensional code information. If the two-dimensional code information is text, the text may be displayed or copied. If the two-dimensional code information is an image, the image may be displayed, enlarged, reduced, or rotated. If the two-dimensional code information is a URL address, the URL address may be copied and a link corresponding to the URL address may be opened. In addition, the processing corresponding to the type of two-dimensional code information may be performed automatically. For example, if the two-dimensional code information is the URL address, the link corresponding to the URL address may be opened directly.

According to various embodiments, a picture triggering event of the web page is monitored. When the two-dimensional code picture is triggered, the picture identification function is provided, so that the two-dimensional code picture on the web page browsed by the user may be identified directly. It is unnecessary to identify the two-dimensional code picture by using a camera or by using a local picture identification software after storing the picture locally, thereby facilitating the user to use the picture identification function.

The parsing module 120 extracts picture resources triggered on the web page, parses the picture resources according to parsing rules pre-stored in a parsing library and obtains two-dimensional code information. According to various embodiments, after the user inputs a URL address or after the user clicks a URL address, the browser may obtain page resources of a web page corresponding to the URL address from a network server, and then display the web page.

The parsing module 120 may be implemented by the browser or by a cloud server located between the browser and the network server. In the parsing procedure, the picture resources are parsed according to the parsing rules in a parsing library. There are various parsing rules in a parsing library, such as parsing rules for pictures containing text coding information and parsing rules for pictures containing URL address coding information. The parsing rules in the parsing library may be obtained from the network according to the requirements.

According to various embodiments, the parsing module 120 further determines whether the parsing library has the parsing rules. If the parsing library has the parsing rules, parse the picture resources by using the parsing rules, and obtain two-dimensional code information. If the parsing library does not have the parsing rules, download parsing rules corresponding to the picture resources, parse the picture resources by using the parsing rules, and obtain two-dimensional code information. According to various embodiments, the parsing rules stored in the parsing library may be updated, thereby enriching the types of the parsing rules in the parsing library and enhancing the ability to identify the picture on the web page.

According to various embodiments, the apparatus may be located at a browser or a server. The server may be an agent server or a cloud server which is located between the browser and the network server. Because of the limitation of the browser, especially the bandwidth limitation of the browser of the mobile terminal, when the apparatus is located at the server, the burden of the mobile terminal is reduced and speed of identifying the picture is improved.

The methods and modules described herein may be implemented by hardware, machine-readable instructions or a combination of hardware and machine-readable instructions. Machine-readable instructions used in the examples disclosed herein may be stored in storage medium readable by multiple processors, such as hard drive, CD-ROM, DVD, compact disk, floppy disk, magnetic tape drive, RAM, ROM or other proper storage device. Or, at least part of the machine-readable instructions may be substituted by specific-purpose hardware, such as custom integrated circuits, gate array, FPGA, PLD and specific-purpose computers and so on.

A machine-readable storage medium is also provided, which stores instructions to cause a machine to execute a method as described herein. A system or apparatus having a storage medium that stores machine-readable program codes for implementing functions of any of the above examples and that may make the system or the apparatus (or CPU or MPU) read and execute the program codes stored in the storage medium.

In this situation, the program codes read from the storage medium may implement any one of the above examples, thus the program codes and the storage medium storing the program codes are part of the technical scheme.

The storage medium for providing the program codes may include floppy disk, hard drive, magneto-optical disk, compact disk (such as CD-ROM, CD-R, CD-RW, DVD-ROM, DVD-RAM, DVD-RW, DVD+RW), magnetic tape drive, Flash card, ROM and so on. Optionally, the program code may be downloaded from a server computer via a communication network.

It should be noted that, alternatively to the program codes being executed by a computer, at least part of the operations performed by the program codes may be implemented by an operation system running in a computer following instructions based on the program codes to realize a technical scheme of any of the above examples.

In addition, the program codes implemented from a storage medium are written in storage in an extension board inserted in the computer or in storage in an extension unit connected to the computer. In this example, a CPU in the extension board or the extension unit executes at least part of the operations according to the instructions based on the program codes to realize a technical scheme of any of the above examples.

The foregoing is various examples of the present disclosure and is not used to limit the protection scope of the present disclosure. Any modification, equivalent substitution, and improvement without departing from the spirit and principle of the present disclosure are within the protection scope of the present disclosure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

What is claimed is:

1. A method for identifying a picture, comprising:
determining, by a computing device, whether a picture is a two-dimensional code picture, after the picture is triggered on a web page displayed by the computing device;
parsing, by the computing device, the two-dimensional code picture when the picture is the two-dimensional code picture;
obtaining, by the computing device, two-dimensional code information; and
performing, by the computing device, processing according to the two-dimensional code information.

2. The method of claim 1, further comprising:
prompting, by the computing device, a user to determine whether to identify the two-dimensional code picture, when the picture is the two-dimensional code picture;
wherein parsing, by the computing device, the two-dimensional code picture when the picture is the two-dimensional code picture comprises:
parsing, by the computing device, the two-dimensional code picture after receiving an instruction of identifying the two-dimensional code picture from the user.

3. The method of claim 2, wherein prompting, by the computing device, the user to determine whether to identify the two-dimensional code picture comprises:
popping-up a shortcut menu comprising a picture identification function.

4. The method of claim 1, wherein parsing, by a computing device, the two-dimensional code picture comprises:
extracting picture resources triggered on the web page;
parsing the picture resources according to parsing rules in a parsing library.

5. The method of claim 4, further comprising:
determining, by the computing device, whether the parsing library has the parsing rules, after extracting picture resources triggered on the web page;
wherein parsing, by the computing device, the picture resources according to parsing rules in a parsing library comprises:
if the parsing library has the parsing rules, parsing the picture resources by using the parsing rules;
if the parsing library does not have the parsing rules, downloading parsing rules corresponding to the picture resources and parsing the picture resources by using the parsing rules.

6. The method of claim 1, wherein performing processing according to the two-dimensional code information comprises:
determining a data type of the two-dimensional code information;
if the data type of the two-dimensional code information is text, displaying the two-dimensional code information;
if the data type of the two-dimensional code information is a URL address, opening a web page corresponding to the URL address.

7. An apparatus for identifying a picture, comprising:
a monitoring module, to determine whether a picture is a two-dimensional code picture after the picture is triggered on a web page displayed on the computing device;
a parsing module, to parse the two-dimensional code picture when the picture is the two-dimensional code picture; and obtain two-dimensional code information; and
a processing module, to perform processing according to the two-dimensional code information.

8. The apparatus of claim 6, wherein the monitoring module further prompts a user to determine whether to identify the two-dimensional code picture when the picture is the two-dimensional code picture; and
the parsing module parses the two-dimensional code picture after receiving an instruction of identifying the two-dimensional code picture from the user.

9. The apparatus of claim 8, wherein
the monitoring module, when prompting the user to determine whether to identify the two-dimensional code picture, pop-ups a shortcut menu comprising a picture identification function.

10. The apparatus of claim 7, wherein
the parsing module extracts picture resources triggered on the web page, parses the picture resources according to parsing rules in a parsing library, and obtains the two-dimensional code information.

11. The apparatus of claim 10, wherein the parsing module further
determines whether the parsing library has the parsing rules after extracting picture resources triggered on the web page; and
wherein parsing the picture resources according to parsing rules in a parsing library, the parsing module
if the parsing library has the parsing rules, parses the picture resources by using the parsing rules;
if the parsing library does not have the parsing rules, downloads parsing rules corresponding to the picture resources and parsing the picture resources by using the parsing rules.

12. The apparatus of claim 7, wherein
the processing module determines a data type of the two-dimensional code information; if the data type of the two-dimensional code information is text, displays the two-dimensional code information; if the data type of the two-dimensional code information is a URL address, opens a web page corresponding to the URL address.

13. The apparatus of claim 7, wherein the apparatus is located at a browser of a mobile terminal or is located at a server.

14. A method for obtaining two-dimensional code information, comprising:
displaying a webpage on a displaying screen of a computing device, the webpage presenting at least one picture;
identifying, by said computing device, two-dimensional code picture from the presented at least one picture to be parsed, while displaying the webpage, the two-dimensional code picture incorporating two-dimensional code;
parsing the two-dimensional code picture, by said computing device; and
obtaining, by one or more processor, two-dimensional code information.

15. The method of claim 14, wherein, after obtaining of the two-dimensional code information, performing processing, by said computing device, according to the two-dimensional code information.

16. The method of claim 14, further comprising:
prompting a user to determine whether to identify the two-dimensional code picture, during process of identification.
